(19) United States
(12) Patent Application Publication
(10) Pub. No.: US 2012/0177912 A1
(43) Pub. Date: Jul. 12, 2012

(54) ADHESIVE COMPOSITION FOR OPTICAL USE

(75) Inventors: Sung Min Kim, Seoul (KR); InKyu Song, Gyeonggi-Do (KR)

(73) Assignee: DONGWOO FINE-CHEM CO., LTD., Jeollabuk-do (KR)

(21) Appl. No.: 13/346,117

(22) Filed: Jan. 9, 2012

(30) Foreign Application Priority Data
Jan. 12, 2011 (KR) 10-2011-0003083

(51) Int. Cl. B32B 3/00; B32B 7/12; C09J 175/16

(52) U.S. Cl. 428/332; 522/96; 526/282; 428/355 N

(57) ABSTRACT

Disclosed is an adhesive composition for optical use and, more particularly, an adhesive composition which includes; 30 to 80 wt. % of a mono-functional urethane acrylate oligomer having a weight average molecular weight of 10,000 and 35,000, 10 to 60 wt. % of an acrylate monomer; and 0.1 to 10 wt. % of a free radical photo-initiator, so as to retain physical properties of the adhesive composition such as coating property and adhesiveness and, in addition, reduce incurring of setting shrinkage during photo-polymerization, thereby exhibiting a uniform thickness and excellent surface appearance, durability such as heat resistance and moist heat resistance, and storage elasticity. Moreover, the inventive composition does not contain an alternative solvent, thus enabling manufacturing of a thick film type adhesive film.

### RELATED APPLICATIONS

This application claims priority from Korean Patent Application No. 10-2011-0003083, filed on Jan. 12, 2011 in the Korean Intellectual Property Office, the entire disclosure of which is incorporated herein by reference.

### BACKGROUND OF THE INVENTION

1. Field of the Invention

The present invention relates to an adhesive composition for optical use, with advantageous features, i.e., a uniform thickness owing to less incurred setting shrinkage, excellent surface appearance, durability such as heat resistance and humidity resistance, and superior storage elasticity, while retaining physical properties of the adhesive itself.

2. Description of the Related Art

In general, a liquid crystal display (LCD) device is comprised of a liquid crystal cell having liquid crystals and a polarizer, and needs a suitable bonding layer or adhesive layer used to combine them.

Such an adhesive layer (film) may be classified into a thin film type adhesive layer and a thick film type adhesive layer, in terms of whether a solvent is used or not.

Among them, the thick film type adhesive layer is generally prepared by subjecting a composition containing an acrylate oligomer or urethane acrylate oligomer, to photo-polymerization.

However, the composition containing the acrylate oligomer shows very slow setting during photo-polymerization, in turn causing low workability (processing properties). On the other hand, the composition containing the urethane acrylate oligomer tends to have deteriorated physical properties of an adhesive layer such as adhesion, although it exhibits considerably rapid setting.

Moreover, photo-polymerization using a composition containing an oligomer having an acryl functional group such as acrylate oligomer, urethane acrylate oligomer, etc., may cause considerably increased setting shrinkage, in turn resulting in irregular thickness of the prepared adhesive layer and/or poor surface appearance, or the like.

### SUMMARY OF THE INVENTION

Therefore, the present invention is directed to providing an adhesive composition with advantageous features including; a uniform thickness attained by low setting shrinkage incurred during photo-polymerization, excellent surface appearance, durability such as heat resistance and humidity resistance, and storage elasticity, while retaining favorable coating properties and adhesiveness equal to or better than conventional products.

Therefore, the present inventors have implemented extensive and intensive studies to accomplish the foregoing purposes. As a result, it was found that, if a urethane acrylate oligomer is added to the composition, shrinking is reduced during photo-polymerization, high adhesion can be maintained, and durability such as heat resistance and humidity resistance and storage elasticity are excellent, thereby completing the present invention.

In addition, it was confirmed that adding a bi-functional urethane acrylate oligomer having a specific range of weight average molecular weight in a predetermined amount to a mono-functional urethane acrylate oligomer having a specific range of weight average molecular weight, may increase the number of functional groups, thus resulting in more excellent durability such as heat resistance and/or humidity resistance. Therefore, the present invention has been completed.

Accordingly, the present invention provides an adhesive composition for optical use, including: 30 to 80% by weight (‘wt. %’) of a mono-functional urethane acrylate oligomer having a weight average molecular weight of 10,000 to 35,000; 10 to 60 wt. % of an acrylate monomer; and 0.1 to 10 wt. % of a free-radical photo-initiator.

The composition may further include 20 wt. % or less of a bi-functional urethane acrylate oligomer having a weight average molecular weight of 5,000 to 15,000.

The mono-functional urethane acrylate oligomer may have a weight average molecular weight of 15,000 to 31,000.

The acrylate monomer may be mono-functional to tetra-functional.

The composition may further include an acrylate resin syrup, an adhesive resin, or a mixture thereof, as an additive.

An adhesive described in the present invention may be a set product of the foregoing adhesive composition.

Additionally, an adhesive film described in the present invention may include a transparent substrate film, and the afore-mentioned adhesive provided on one face of the transparent substrate film.

The adhesive described above may have a thickness ranging from 25 to 1000 μm.

Accordingly, the adhesive composition of the present invention has advantageous features including; a uniform thickness attained by low setting shrinkage incurred during photo-polymerization, excellent surface appearance, durability such as heat resistance and humidity resistance, and storage elasticity, while retaining favorable coating properties and adhesiveness equal to or better than conventional products.

Moreover, the inventive composition does not contain an alternative solvent, thus enabling manufacturing of a thick film type adhesive film.

### DETAILED DESCRIPTION OF THE INVENTION

The present invention discloses an adhesive composition for optical use, with advantageous features including; a uniform thickness owing to less incurred setting shrinkage, excellent surface appearance, durability such as heat resistance and humidity resistance, and superior storage elasticity, while retaining physical properties of the adhesive itself.

Hereinafter, the present invention will be described in more detail.

An adhesive composition for optical use according to the present invention comprises: 30 to 80 wt. % of a mono-functional urethane acrylate oligomer having a weight average molecular weight of 10,000 to 35,000; 10 to 60 wt. % of an acrylate monomer; and 0.1 to 10 wt. % of a free-radical photo-initiator.

The urethane acrylate oligomer may be comprised of a main chain component such as polyether, polyester and/or polycarbonate and, in addition, a reactive end group and a urethane bonding group. The main chain component may be preferably polyether in aspects of low viscosity and low cost.

Polyether generally comprises polymer diol or polyol and hydroxylic acid components, and preferably usable polyols may include, for example, polyether diol, hydrocarbon diol, polycarbonate diol, polyacrylate polyol (hydroxyl functional acryl polymer), polycaprolactone diol, etc. Such polyols may be used alone or in combination of two or more thereof.

Polymerization of constitutional units of the polyol is not particularly limited but may include block polymerization or graft polymerization.

The polyether diol may be obtained by open-ring copolymerization of polyethyleneglycol, polypropyleneglycol, polytetramethylglycol, polyhexamethyleneglycol, polyheptamethyleneglycol, polydecamethyleneglycol and at least two or more of ionic-polymerization cyclic compounds.

The ionic-polymerization cyclic compound may include a cyclic ether, i.e., ethylene oxide, propylene oxide, butane-1-oxide, isobutene oxide, 3,3′-bischloromethyl oxetane, tetrahydrofuran, 2-methyl tetrahydrofuran, 3-methyl tetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyl oxetane, vinyl tetrahydrofuran, vinyl cyclohexene oxide, phenyl glycidyl ether, butyl glycidyl ether, glycidyl benzoate, or the like.

Particular examples of a polyether diol formed by open-ring copolymerization of at least two kinds among the foregoing ionic-polymerization cyclic compounds may include a copolymer formed by a combination of: tetrahydrofuran and propylene oxide; tetrahydrofuran and 2-methyl tetrahydrofuran; tetrahydrofuran and 3-methyl tetrahydrofuran; tetrahydrofuran and ethylene oxide; propylene oxide and ethylene oxide; and ethylene oxide and butene-1-oxide, and/or a terpolymer formed by a combination of tetrahydrofuran, ethylene oxide and butene-1-oxide.

In addition, polyether diol obtained by executing open-ring copolymerization of one among the foregoing ionic-copolymerization cyclic compounds with a cyclic imine such as ethyleneimine; a cyclic lactone such as β-propiolactone and glycolic acid lactide; or dimethylcyclo polysiloxane, may be used. Such an open-ring copolymer of the ionic-polymerization cyclic compound may be a random copolymer or a block copolymer.

According to the present invention, the urethane acrylate oligomer may be mono-functional and have a weight average molecular weight of 10,000 to 35,000 and, more preferably, 15,000 to 31,000, in consideration of adhesiveness and durability thereof.

The urethane acrylate oligomer is generally used in the related art and may have at least one main chain selected from a group consisting of polyester, polyether and polycarbonate. Considering durability and low viscosity, polyester or polyether are preferably used. Here, types of functional groups are not particularly limited.

When the weight average molecular weight is less than 10,000, durability may be reduced. On the other hand, if the weight average molecular weight exceeds 35,000, problems such as a decrease in adhesiveness and durability may be simultaneously incurred.

Such mono-functional urethane acrylate oligomer may be added in an amount of 30 to 80 wt. %, relative to a total content of the adhesive composition. If the content is less than 30 wt. %, a content of the acrylate monomer is relatively increased to cause setting shrinkage. On the other hand, when the content of the mono-functional urethane acrylate oligomer exceeds 80 wt. %, a reduction in setting (that is, decrease in a degree of curing) may be caused.

Alternatively, the present invention may use a bi-functional urethane acrylate oligomer having a weight average molecular weight of 5,000 to 15,000, which is added in a predetermined amount to the mono-functional urethane acrylate oligomer having a weight average molecular weight of 10,000 to 35,000.

The bi-functional compound is generally used in the related art without being particularly limited, however, may have at least one main chain selected from a group consisting of polyester, polyether and polycarbonate and, in consideration of durability and low viscosity, polyester or polyether is preferably used. In this case, types of functional groups are not particularly limited.

In addition, the weight average molecular weight is less than 5,000, durability may be reduced. On the other hand, when the weight average molecular weight exceeds 15,000, a problem of decreasing adhesiveness may be caused.

Such a bi-functional urethane acrylate oligomer may be added in an amount of 20 wt. % or less, preferably, 10 to 20 wt. %, relative to a total content (100 wt. %) of the adhesive composition. If the content exceeds 20 wt. %, adhesiveness may be deteriorated.

The acrylate monomer may impart durability to a film containing the adhesive composition and also retain desired viscoelastic properties. Also, this may control a viscosity to improve coating properties of the composition.

The acrylate monomer may comprise mono- to tetra-functional acrylate monomers and practical examples thereof may include: mono-functional monomers such as ethyl acrylate, methyl(meth)acrylate, 2-ethylhexyl(meth)acrylate, butyl acrylate, isobutyl acrylate, allyl methacrylate, 2-ethoxyethyl(meth)acrylate, isodecyl(meth)acrylate, 2-dodecylthioethyl methacrylate, octyl acrylate, isooctyl acrylate, 2-methoxyethyl acrylate, hydroxyethyl(meth)acrylate, hydroxypropyl(meth)acrylate, hydroxybutyl(meth)acrylate, isooctyl(meth)acrylate, isodexyl(meth)acrylate, stearyl(meth)acrylate, tetraperfuryl(meth)acrylate, phenoxyethyl(meth)acrylate, octadecyl(meth)acrylate, isobonyl(meth)acrylate, tetrahydrofuryl acrylate, acryloyl morpholine, etc.; bi-functional monomers such as 1,3-butandiol di(meth)acrylate, 1,4-butandiol di(meth)acrylate, 1,6-hexandiol di(meth)acrylate, ethyleneglycol di(meth)acrylate, bisophenol A-ethyleneglycol diacrylate, diethyleneglycol di(meth)acrylate, triethyleneglycol di(meth)acrylate, polyethyleneglycol di(meth)acrylate, propyleneglycol di(meth)acrylate, dipropyleneglycol di(meth)acrylate, tripropyleneglycol di(meth)acrylate, neopentylglycol di(meth)acrylate, dicyclopentanyl di(meth)acrylate, caprolactone modified dicyclopentenyl di(meth)acrylate, ethylene oxide modified di(meth)acrylate phosphate, bis(2-hydroxylethyl)isocyanurate di(meth)acrylate, di(acryloxyethyl)isocyanurate, allylated cyclohexyl di(meth)acrylate, dimethylol dicyclopentane diacrylate, ethylene oxide modified hexahydrophthalic acid diacrylate, tricyclodecanedimethanol acrylate, neopentylglycol modified trimethylolpropane diacrylate, adamantane diacrylate, etc.; tri-functional monomers such as trimethylolpropane tri(meth)acrylate, pentaerythritol tri(meth)acrylate, dipentaerythritol tri(meth)acrylate, propionic acid modified dipentaerythritol tri(meth)acrylate, propylene oxide modified trimethylolpropane tri(meth)acrylate, tris(2-hydroxylethyl)isocyanurate tri(meth)acrylate, tris(acryloxyethyl)isocyanurate, glycerol tri(meth)acrylate, etc.; and tetra-functional monomers such as diglycerin tetra(meth)acrylate, pentaerythritol tetra(meth)acrylate, ditrimethylolpropane tetra(methyl)acrylate, etc., which are used alone or as a mixture of two or more thereof.

Content of the acrylate monomer may range from 10 to 60 wt. %, preferably, 20 to 50 wt. %, relative to a total content (100 wt. %) of the adhesive composition. If the content is less than 10 wt. %, a setting rate is low or a storage elasticity is too low, in turn causing cohesive failure. On the other hand, if the content exceeds 60 wt. %, a coating property problem may be incurred due to significant setting shrinkage.

A free radical photo-initiator may have a role of sufficiently facilitating internal and/or surface setting of the adhesive, and types or kinds thereof are not particularly limited so long as they are known in the related art.

Particular examples of such a free radical photo-initiator may include; benzoin, bezoin methylether, benzoin ethylether, benzoin isopropylether, benzoin-n-butylether, benzoin isobutylether, acetophenone, hydroxymethyl acetophenone, dimethylamino acetophenone, dimethoxy-2-phenyl acetophenone, 3-methyl acetophenone, 2,2-dimethoxy-2-phenyl acetophenone, 2,2-diethoxy-2-phenyl acetophenone, 4-chloroacetophenone, 4,4-dimethoxy acetophenone, 2-hydroxy-2-methyl-1-phenylpropane-1-on, 4-hydroxy cyclophenylketone, 1-hydroxy cyclohexylphenylketone, 2-methyl-1-[4-(methylthio)phenyl]-2-morpholino-propane-1-on, 4-(2-hydroxyethoxy)phenyl-2-(hydroxy-1-propyl)ketone, benzophenone, p-phenylbenzophenone, 4,4-diaminobenzophenone, 4,4′-diethylaminobenzophenone, dichlorobenzophenone, anthraquinone, 2-methyl anthraquinone, 2-ethyl anthraquinone, 2-t-butyl anthraquinone, 2-amino anthraquinone, 2-methylthioxantone, 2-ethylthioxantone, 2-chlorothioxantone, 2,4-dimethylthioxantone, 2,4-diethylthioxantone, benzyldimethylketal, diphenylketone benzyldimethylketal, acetophenone dimethylketal, p-dimethylamino benzoic acid ester, 2,4,6-trimethylbenzoyl-diphenyl-phosphine oxide, fluorene, triphenylamine, carbazole, etc. Alternatively, commercially available products, i.e., Darocur 1173, Igacure 184, Igacure 907, Igacure-1700 (Ciba Co.), or the like, may also be employed. These may be use alone or in combination of two or more thereof.

The free radical photo-initiator may be used in a desired amount, in consideration of radiation or intensity of a light source, contents of respective components thereof, and is preferably included in an amount of 0.1 to 10 wt. % relative to a total content of the adhesive composition (100 wt. %).

Other than the foregoing, the adhesive composition of the present invention may further include an acrylate resin syrup, an adhesive resin or a mixture thereof, as an additive.

The adhesive resin, that is, an adhesion-imparting resin may be used to improve adhesiveness while controlling a viscosity of the composition. Examples thereof may include, rosin ester, synthesized hydrocarbons, etc. Specially, the rosin ester is preferably exemplified by Poral 85 LB products having a ring and/or ball softening point (ASTM E 28) of 65° C., which are commercially available from Eastman Chemicals (Middleburg, The Netherlands).

The acrylate resin syrup is a resin syrup in which acrylic monomer and polyacrylate as a polymerized product thereof are dissolved, and which functions to exhibit favorable storage elasticity advantageous in management and adhesion processes of an adhesive film.

The acrylic monomer may include; acrylic acid, methyl acrylate, ethyl acrylate, isopropyl acrylate, n-butyl acrylate, 2-ethylhexyl acrylate, isobornyl acrylate, etc.

The polyacrylate may comprise a polymer such as methyl acrylate, ethyl acrylate, isopropyl acrylate, n-butyl acrylate, 2-ethylhexyl acrylate, etc. Among them, 2-ethylhexyl acrylate (2-EHA) is most preferably used.

The foregoing additive may be contained (or added) with a suitable range wherein desired effects of the inventive adhesive composition are accomplished. Preferably, the content of the additive is not more than 20 wt. % relative to a total content (100 wt. %) of the adhesive composition.

The adhesive composition of the present invention may be set (that is, cured) to form an adhesive. In addition, an adhesive film comprising a transparent film and the afore-mentioned additive formed at one face of the transparent film may be fabricated.

The adhesive may have a thickness of 25 to 1000 μm.

The transparent substrate film may have excellent transparency, mechanical strength, thermal stability, moisture shielding properties, isotropic properties, etc., without being particularly limited.

The setting is known and used in the related art and generally includes UV photo-setting, without being particularly limited.

Polymerization via the UV photo-setting described above may be performed using a light source with a light emitting distribution wavelength of 400 nm or less, preferably, 150 to 400 nm, more preferably, 200 to 380 nm. For instance, a low pressure mercury lamp, a medium pressure mercury lamp, a high pressure mercury lamp, a ultra-high pressure mercury lamp, a chemical lamp, a black light lamp, a micro-wave excited mercury lamp, a metal halide lamp, or the like, may be used.

An intensity of the light irradiation may be controlled depending upon physical properties of the adhesive. An integrated light quantity useful for activation of the free radical photo-initiator may range from 10 to 5000 mJ/cm², preferably, 200 to 800 mJ/cm². The foregoing range is preferable since a setting reaction time is suitably provided and some problems including, decrease in cohesion of set products prepared by radiant heat of the lamp and/or exothermic heat during polymerization, yellowing, deterioration of a support, etc., are not incurred.

Hereinafter, preferred embodiments will be described to more concretely understand the present invention with reference to examples and comparative examples. However, it will be apparent to those skilled in the art that such embodiments are provided for illustrative purposes and various modifications and alterations may be possible without departing from the scope and spirit of the present invention, and such modifications and alterations are duly included in the present invention as defined by the appended claims.

### EXAMPLE

### Example 1

### (1) Adhesive Composition

65 wt. % of a mono-functional urethane acrylate oligomer (trade name DFCN-5, Negami Chemical, a weight average molecular weight=31,000), 28 wt. % of an isobonyl acrylate as an acrylate monomer, 5 wt. % of 1,6-hexanediol diacrylate and 2 wt. % of a free radical photo-initiator (Ciba Co., trade name Darocur-1173) were mixed to prepare an adhesive composition.

### (2) Preparation of Adhesive Film

After applying the prepared adhesive composition in the above (1) to a transparent substrate film coated with a silicon releasing agent to have a thickness of 300 μm, the same transparent substrate film as the foregoing is further laminated above the coated film. Then, through UV irradiation at a rate of 4 m/min (600 mJ/cm²), the above laminated film was completely set to form an adhesive.

### Examples 2 to 13 and Comparative Examples 1 to 5

The same procedure as described in Example 1 was executed, except that respective components of the composition used herein were shown in TABLE 1 below.

TABLE 1

| | Mono-functional urethane | | | | | | Bi-functional urethane | | | | | Acrylate | | Free radical | Acrylate |
|---|---|---|---|---|---|---|---|---|---|---|---|---|---|---|---|
| Section | acrylate oligomer | | | | | | acrylate oligomer | | | | | monomer | | photo- | resin |
| (wt. %) | A-1 | A-2 | A-3 | A-4 | A-5 | A-6 | B-1 | B-2 | B-3 | B-4 | B-5 | C-1 | C-2 | initiator | syrup |
| Ex. 1 | 65 | — | — | — | — | — | — | — | — | — | — | 28 | 5 | 2 | — |
| Ex. 2 | — | 65 | — | — | — | — | — | — | — | — | — | 28 | 5 | 2 | — |
| Ex. 3 | — | — | 65 | — | — | — | — | — | — | — | — | 28 | 5 | 2 | — |
| Ex. 4 | — | — | — | 65 | — | — | — | — | — | — | — | 28 | 5 | 2 | — |
| Ex. 5 | 45 | — | — | — | — | — | 20 | — | — | — | — | 28 | 5 | 2 | — |
| Ex. 6 | 45 | — | — | — | — | — | — | 20 | — | — | — | 28 | 5 | 2 | — |
| Ex. 7 | 45 | — | — | — | — | — | — | | 20 | — | — | 28 | 5 | 2 | — |
| Ex. 8 | 45 | — | — | — | — | — | — | | — | 20 | — | 28 | 5 | 2 | — |
| Ex. 9 | 45 | — | — | — | — | — | — | | — | — | 20 | 28 | 5 | 2 | — |
| Ex. 10 | 45 | — | — | — | — | — | — | — | — | — | 15 | 33 | 5 | 2 | — |
| Ex. 11 | 45 | — | — | — | — | — | — | — | — | — | — | 48 | 5 | 2 | — |
| Ex. 12 | 80 | — | — | — | — | — | — | — | — | — | — | 13 | 5 | 2 | — |
| Ex. 13 | 30 | — | — | — | — | — | — | 25 | — | — | — | 28 | 5 | 2 | 10 |
| Com. Ex. 1 | — | — | — | — | 65 | — | — | — | — | — | — | 28 | 5 | 2 | — |
| Com. Ex. 2 | — | — | — | — | — | 65 | — | — | — | — | — | 28 | 5 | 2 | — |
| Com. Ex. 3 | — | — | — | — | — | — | 65 | — | — | — | — | 28 | 5 | 2 | — |
| Com. EX. 4 | 25 | — | — | — | — | — | — | — | — | — | — | 68 | 5 | 2 | — |
| Com. Ex. 5 | 85 | — | — | — | — | — | — | — | — | — | — | 8 | 5 | 2 | — |

A-1: Trade name DFCN-5, Negami Chemical, weight average molecular weight (Mw) = 31,000
A-2: Trade name DFCN-1, Negami Chemical, weight average molecular weight (Mw) = 10,000
A-3: Trade name DFCN-2, Negami Chemical, weight average molecular weight (Mw) = 21,000
A-4: Trade name DFCN-4, Negami Chemical, weight average molecular weight (Mw) = 35,000
A-5: Trade name DFCN-3, Negami Chemical, weight average molecular weight (Mw) = 9,500
A-6: Trade name DFCN-6, Negami Chemical, weight average molecular weight (Mw) = 38,000
B-1: Trade name UN-6200, Negami Chemical, weight average molecular weight (Mw) = 6,500
B-2: Trade name UN-6202, Negami Chemical, weight average molecular weight (Mw) = 11,000
B-3: Trade name UN-9200A, Negami Chemical, weight average molecular weight (Mw) = 13,000
B-4: Trade name KY-101, Negami Chemical, weight average molecular weight (Mw) = 3,000
B-5: Trade name UN-6301, Negami Chemical, weight average molecular weight (Mw) = 33,000
C-1: Isobonyl acrylate
C-2: 1,6-Hexanediol diacrylate
Free radical photo-initiator: Ciba Co., Darocur-1173
Acrylate resin syrup: Trade name SY-1063, Negami Chemical

### Experimental Example

Each of the prepared adhesive compositions and adhesion films according to the foregoing examples and Comparative Examples was subjected to measurement of physical properties by the following procedures, results thereof are shown in TABLE 2.

1. Adhesiveness (N/25 mm)

After delaminating the substrate film coated with a releasing agent applied thereto from the adhesive film, another substrate film without a releasing process was laminated. The adhesive sheet was cut into a dimension of 25 mm×250 mm using a super cutter, attached to a glass, fixed to an autograph, and treated by 180° peel releasing at a rate of 300 m/min, which in turn was subjected to determination of adhesiveness.

2. Adhesive Failure Status

By observing a status of a glass surface during determining adhesiveness described above, results thereof were assessed on the basis of the following standards.

<Standards of Assessment>

⊚—very clean surface of the glass without residue of adhesive.

o—clean surface of the glass with few traces of adhesive.

x—adhesive residue and foreign material are still present in large quantities on the surface of the glass (cohesive failure).

3. Storage Elasticity

After preparing a cylindrical specimen having a diameter of 25 mm and a thickness of 1 mm, storage elasticity of the prepared specimen (that is, adhesive film) was determined according to a torsional share method.

Measurement device: Dynamic viscoelasticity measuring device (MCR 300, PSICA Co.)

Frequency: 1 Hz

Measurement temperature: 23° C.

4. Setting Shrinkage

After coating the prepared adhesive composition into a thickness of 300 μm, setting was carried out by irradiating UV light at a rate of 4 m/min (600 mJ/cm²) using a UV radiator. After visibly observing a surface of the set coating layer, results thereof were assessed according to the following standards.

<Standards of Assessment>

⊚—No incurring of setting shrinkage. Uniform and clean surface is observed.

o—Setting shrinkage is a little incurred, however, causing no problems in external appearance. Surface is mostly uniform and clean.

x—Problems in external appearance incurred due to setting shrinkage. Surface is irregular and contaminated (Incomplete setting).

5. Heat Resistance

After delaminating the substrate film coated with a releasing agent from the adhesive film, a treated film was laminated above a PET film without a releasing process. The adhesive sheet was cut into an A4 size using a super cutter, adhered to a glass, treated in an autoclave at 50° C. and 5 atms for 20 minutes, and then, left in a heat resistant oven at 80° C. for 100 hours.

⊚—After assessing heat resistance, failures such as bubbling are not detected.

o—After assessing heat resistance, less than 10 air bubbles having a size of less than 1 μm are generated along a peripheral side of the sheet.

Δ—After assessing heat resistance, 10 or more air bubbles having a size of less than 1 μm are generated along a peripheral side of the sheet.

x—After assessing heat resistance, severe bubbling and/or delamination are resulted.

6. Humidity Resistance

After delaminating the substrate film coated with a releasing agent from the adhesive film, a treated film was laminated above a PET film without a releasing process. The adhesive sheet was cut into a A4 size using a super cutter, adhered to a glass, treated in an autoclave at 50° C. and 5 atms for 20 minutes, and then, left in a humidity resistant oven at 60° C. and 60 RH % for 100 hours.

⊚—After assessing humidity resistance, failures such as bubbling are not detected.

o—After assessing humidity resistance, less than 10 air bubbles having a size of less than 1 μm are generated along a peripheral side of the sheet.

Δ—After assessing humidity resistance, 10 or more of air bubbles having a size of less than 1 μm are generated along a peripheral side of the sheet.

x—After assessing humidity resistance, severe bubbling and/or delamination are resulted.

7. Setting Rate (Coating Properties)

Consumption extent of unsaturated C—C double bonds among unsaturated groups contained in both of urethane acrylate oligomer component and acrylate monomer component during setting, as a function of time, was determined by a Fourier Transform Infrared Spectrometry (FT-IR) technique.

Assessment device: FT-IR

Measurement method: Measuring disappearance level of unsaturated C—C double bonding signal at 810 cm⁻¹.

Percentage of consumption means percentage of double bonds disappeared during UV irradiation with 0% before the irradiation.

TABLE 2

| | | Adhesive | Storage | Setting | Heat | Humidity | Setting |
|---|---|---|---|---|---|---|---|
| Section | Adhesiveness | failure | elasticity | shrinkage | resistance | resistance | rate |
| Ex. 1 | 24.5 | ⊚ | 3.07 × 10⁵ | ⊚ | ◯ | ◯ | 98 |
| Ex. 2 | 21.0 | ⊚ | 3.54 × 10⁵ | ⊚ | Δ | Δ | 97 |
| Ex. 3 | 16.0 | ⊚ | 3.82 × 10⁵ | ⊚ | ◯ | ◯ | 97 |
| Ex. 4 | 20.5 | ⊚ | 3.14 × 10⁵ | ⊚ | ◯ | Δ | 97 |
| Ex. 5 | 18.2 | ⊚ | 4.51 × 10⁵ | ⊚ | ⊚ | ⊚ | 97 |
| Ex. 6 | 20.4 | ⊚ | 4.11 × 10⁵ | ⊚ | ⊚ | ⊚ | 97 |
| Ex. 7 | 17.3 | ⊚ | 4.12 × 10⁵ | ⊚ | ⊚ | ⊚ | 97 |
| Ex. 8 | 15.5 | ⊚ | 5.41 × 10⁵ | ⊚ | ⊚ | ⊚ | 97 |
| Ex. 9 | 12.7 | ⊚ | 5.93 × 10⁵ | ⊚ | ⊚ | ⊚ | 97 |
| Ex. 10 | 13.4 | ⊚ | 5.7 × 10⁵ | ⊚ | ⊚ | ⊚ | 97 |
| Ex. 11 | 28.4 | ⊚ | 4.32 × 10⁵ | ◯ | ◯ | ◯ | 97 |
| Ex. 12 | 15.2 | ◯ | 2.85 × 10⁵ | ⊚ | ◯ | ◯ | 72 |
| Ex. 13 | 27.3 | ⊚ | 4.03 × 10⁵ | ⊚ | ◯ | ◯ | 97 |
| Com. Ex. 1 | 18.5 | ⊚ | 2.31 × 10⁵ | ⊚ | X | Δ | 97 |
| Com. Ex. 2 | 4.5 | ⊚ | 2.51 × 10⁵ | ⊚ | X | Δ | 97 |
| Com. Ex. 3 | 3.6 | ⊚ | 2.71 × 10⁵ | ⊚ | X | Δ | 97 |
| Com. Ex. 4 | 21.2 | ⊚ | 5.13 × 10⁵ | X | X | X | 97 |
| Com. Ex. 5 | 20.2 | ⊚ | 1.8 × 10⁵ | ⊚ | X | X | 55 |

As shown in the above table, it was confirmed that each of the adhesive compositions described in Examples 1 to 13 according to the present invention wherein a mono-functional urethane acrylate oligomer having a weight average molecular weight of 10,000 to 35,000, an acrylate monomer and a free radical photo-initiator, are included in desired contents, may retain physical properties itself such as coating properties and adhesiveness and has reduced setting shrinkage during photo-polymerization, thus accomplishing uniform thickness, excellent surface appearance, and superior durability such as heat resistance and humidity resistance and storage elasticity.

In addition, it can be seen that Examples 5 to 10 executed using a mixture of a mono-functional urethane acrylate oligomer having a weight average molecular weight of 10,000 to 35,000 as well as a bi-functional urethane acrylate oligomer having a weight average molecular weight of 5,000 to 15,000 exhibit further improved durability such as heat resistance and humidity resistance.

On the other hand, Comparative Example 1 executed using a mono-functional urethane acrylate oligomer having a weight average molecular weight of less than 10,000 showed low durability, while Comparative Examples 2 and 3 describing the use of a mono-functional urethane acrylate oligomer having a weight average molecular weight of more than 35,000 and a bi-functional urethane acrylate oligomer, respectively, exhibited deteriorated adhesiveness and durability.

In addition, the product having less than 30 wt. % of the mono-functional urethane acrylate in Comparative Example 4 showed considerable setting shrinkage, thus not being employed as a commercial product. On the other hand, the product having more than 80 wt. % of the mono-functional urethane acrylate in Comparative Example 5 had too low a setting rate, thus causing deterioration in durability as well as displacement (transfer) of the adhesive at delamination.

While the present invention has been described with reference to the preferred embodiments, it will be understood by those skilled in the related art that various modifications and variations may be made therein without departing from the scope of the present invention as defined by the appended claims.

What is claimed is:

1. An adhesive composition for optical use, comprising: 30 to 80 wt. % of a mono-functional urethane acrylate oligomer having a weight average molecular weight of 10,000 to 35,000; 10 to 60 wt. % of an acrylate monomer; and 0.1 to 10 wt. % of a free radical photo-initiator.

2. The composition according to claim 1, further comprising a bi-functional urethane acrylate oligomer having a weight average molecular weight of 5,000 to 15,000, in an amount of 20 wt. % or less.

3. The composition according to claim 1, wherein the mono-functional urethane acrylate oligomer has a weight average molecular weight of 15,000 to 31,000.

4. The composition according to claim 1, wherein the acrylate monomer is mono-functional to tetra-functional.

5. The composition according to claim 1, further including an additive selected from an acrylate resin syrup, an adhesive resin or a mixture thereof.

6. An adhesive formed by setting the adhesive composition according to any one of claims 1 to 5.

7. An adhesive film comprising:
a transparent substrate film; and
the adhesive according to claim 6 formed on one face of the transparent substrate film.

8. The adhesive film according to claim 7, wherein the adhesive has a thickness of 25 to 1000 μm.
